(19) United States
(12) Patent Application Publication
(10) Pub. No.: US 2008/0024510 A1
(43) Pub. Date: Jan. 31, 2008

(54) TEXTURE ENGINE, GRAPHICS PROCESSING UNIT AND VIDEO PROCESSING METHOD THEREOF

(75) Inventors: Chuan-Chen Lee, Taipei (TW); Ming-Hsuan Tan, Taipei (TW); Ko-Fang Wang, Taipei (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: VIA TECHNOLOGIES, INC., Taipei (TW)

(21) Appl. No.: 11/460,319

(22) Filed: Jul. 27, 2006

(51) Int. Cl. G09G 5/00

(52) U.S. Cl. 345/582

(57) ABSTRACT

The texture engine, provided in this disclosure, comprises a texel location calculator, a texture cache unit, and a video processing unit. The texel location calculator receives a texture and video request for a pixel, including location information of texture data for the pixel in a texture map stored in a memory unit and information of video processing required for the pixel. The texel location calculator computes memory addresses of the texture data in the memory unit and graphics data required for the pixel when performing the video processing specified in the texture and video request in the memory unit. The texture cache unit retrieves a copy of the graphics data and texture data from the memory unit with the memory addresses computed by the texel location calculator. The video processing unit receives the graphics data to perform the video processing specified in the texture and video request on the graphics data.

### BACKGROUND OF THE INVENTION

1. Field of the Invention

The present invention relates to a texture engine, and more specifically to a texture engine comprising a texture cache unit for implementing video functions on pixel data.

2. Description of the Related Art

In computer graphics applications, scene geometry is typically represented by geometric primitives, such as points, lines, polygons (for example, triangles and quadrilaterals), and curved surfaces, defined by one or more two- or three-dimensional vertices, wherein each vertex may have additional scalar or vector attributes used to determine qualities such as the color, transparency, lighting, shading, and animation of the vertex and its associated geometric primitives. These primitives, in turn, are formed by the interconnection of individual pixels. Color and texture are then applied to the individual pixels having the shape based on their location within the primitive and the primitive's orientation with respect to the generated shape, thereby generating the object that is rendered to a corresponding display for subsequent viewing.

As graphics applications increase in complexity and reality, computer systems with graphics processing systems adapted to accelerate the rendering process have become widespread. To meet current demands for graphics, graphics processing units (GPUs), sometimes also called graphics accelerators, have become an integral component in computer systems. In the present disclosure, the term graphics controller refers to either a GPU or graphics accelerator. In computer systems, GPUs control the display subsystem of a computer such as a personal computer, workstation, personal digital assistant (PDA), or any device with a display monitor. The interconnection of primitives and the application of color and textures to generated shapes are generally performed by GPUs. Conventional GPUs include a plurality of shaders specifying how and with what corresponding attributes a final image being drawn on a screen, or suitable display device.

FIG. 1 is a block diagram of a conventional GPU 100, comprising a vertex shader 102, a setup engine 104, a primitive engine 106, a pixel shader 108, a texture engine 110, and a writeback engine 112. The vertex shader 102 receives image data, performing mathematical operations on the vertices of each primitive which may include transformation operation, lighting and clipping. The setup engine 104 receives the vertex data from the vertex shader 102 and performs geometry assembly, wherein the received vertices are assembled into triangles. Once each of the triangles that create a 3D scene have been arranged, the primitive engine 106 converts the previously assembled primitives into pixel data being transmitted to the pixel shader 108. The pixel shader 108 loads pixel shader (PS) instructions to execute operations on each pixel data set, for generating the color and additional appearance attributes applied to a given pixel and applying the appearance attributes to the respective pixels. In addition, the pixel shader 108 fetches texture data for each pixel. The texture engine 110 receives texture requests from the pixel shader 108 and provides textures requested thereto according to the received texture requests. Once pixel shading is complete, pixel data is passed to the writeback engine 112. The writeback engine 112 writes back the modified pixel color and depth values for each pixel data received from the pixel shader 108. The combination of each incoming pixel data set with corresponding pixel values is then output to a frame buffer to be presented to the output display.

Generally, to implement video functions such as de-interlacing, scaling, de-blocking and color space transformation, the pixel shader 108 is usually applied with programmable PS codes to implement desired video functions. However, it may require several PS instructions to implement a video function, degrading execution efficiency then worsened performance when various video functions are required. Table 1 illustrates exemplary PS code piece of 4×4 filtering and color space transformation.

TABLE 1

| dcl | t0 | | | |
|---|---|---|---|---|
| dcl | h00, h01, h02, h03 // filter coefficients | | | |
| dcl | h10, h11, h12, h13 // filter coefficients | | | |
| dcl | h20, h21, h22, h23 // filter coefficients | | | |
| dcl | h30, h31, h32, h33 // filter coefficients | | | |
| dcl | c0, c1, c2 // color space conversion coefficients | | | |
| dcl | dst | // unit vectors along s-direction and t-direction | | |
| mad | t_00 | t0 | (1111) | -dst |
| mad | t_01 | t0 | (1111) | -dst.0gba |
| mad | t_02 | r_01 | (1111) | dst.r0ba |
| mad | t_03 | r_02 | (1111) | dst.r0ba |
| mad | t_10 | t0 | (1111) | -dst.r0ba |
| mad | t_12 | t0 | (1111) | dst.r0ba |
| mad | t_13 | t_12 | (1111) | dst.r0ba |
| mad | t_20 | t_10 | (1111) | dst.0gba |
| mad | t_21 | t_20 | (1111) | dst.r0ba |
| mad | t_22 | t_21 | (1111) | dst.r0ba |
| mad | t_23 | t_22 | (1111) | dst.r0ba |
| mad | t_30 | t_20 | (1111) | dst.0gba |
| mad | t_31 | t_30 | (1111) | dst.r0ba |
| mad | t_32 | t_31 | (1111) | dst.r0ba |
| mad | t_33 | t_32 | (1111) | dst.r0ba |

| | | |
|---|---|---|
| texld | r_00 | t_00 |
| texld | r_01 | t_01 |
| texld | r_02 | t_02 |
| texld | r_03 | t_03 |
| texld | r_10 | t_10 |
| texld | r_11 | t0 |
| texld | r_12 | t_12 |
| texld | r_13 | t_13 |
| texld | r_20 | t_20 |
| texld | r_21 | t_21 |
| texld | r_22 | t_22 |
| texld | r_23 | t_23 |
| texld | r_30 | t_30 |
| texld | r_31 | t_31 |
| texld | r_32 | t_32 |
| texld | r_33 | t_33 |

| | | | | |
|---|---|---|---|---|
| mul | r0 | r_00 | h00 | (0000) |
| mul | r1 | r_01 | h01 | (0000) |
| mul | r2 | r_02 | h02 | (0000) |
| mad | r4 | r0 | (1111) | r1 |
| mad | r4 | r4 | (1111) | r2 |
| mad | r4 | r_03 | h03 | r4 |
| mul | r0 | r_10 | h10 | (0000) |
| mul | r1 | r_11 | h11 | (0000) |
| mul | r2 | r_12 | h12 | (0000) |
| mad | r5 | r0 | (1111) | r1 |
| mad | r5 | r5 | (1111) | r2 |
| mad | r5 | r_13 | h13 | r5 |
| mad | r5 | r4 | (1111) | r5 |
| mul | r0 | r_20 | h20 | (0000) |
| mul | r1 | r_21 | h21 | (0000) |
| mul | r2 | r_22 | h22 | (0000) |
| mad | r4 | r0 | (1111) | r1 |
| mad | r4 | r4 | (1111) | r2 |
| mad | r4 | r_23 | h23 | r4 |
| mad | r4 | r4 | (1111) | r5 |
| mul | r0 | r_30 | h30 | (0000) |
| mul | r1 | r_31 | h31 | (0000) |
| mul | r2 | r_32 | h32 | (0000) |
| mad | r0 | r0 | (1111) | r1 |
| mad | r0 | r0 | (1111) | r2 |
| mad | r0 | r_33 | h30 | r0 |
| mad | r0 | r4 | (1111) | r0 |
| dp3 | r0.r | r0 | c0 | |
| dp3 | r0.g | r0 | c1 | |
| dp3 | r0.b | r0 | c2 | |
| mov | oC0 | r0 | | |

wherein hᵢⱼ represents filter coefficients, ds represents unit vector along s-direction and dt represents unit vector along t-direction. As shown in the Table 1, it takes a lot of PS instructions to perform simple video functions such as filtering and color space transformation.

Thus, it is advantageous to have a GPU capable of implementing 2D video functions efficiently.

### BRIEF SUMMARY OF INVENTION

A detailed description is given in the following embodiments with reference to the accompanying drawings.

The invention is generally directed to a texture engine capable of performing video processing in a graphics processing unit (GPU). An exemplary embodiment of a texture engine comprises a texel location calculator receiving a texture and video request for a pixel, including location information of texture data for the pixel in a texture map stored in a memory unit and information of video processing required for the pixel, the texel location calculator computing memory addresses of the texture data in the memory unit and graphics data required for the pixel when performing the video processing specified in the texture and video request in the memory unit; a texture cache unit retrieving a copy of the graphics data and the texture data from the memory unit with the memory addresses computed by the texel location calculator; and a video processing unit, coupled to the texture cache unit, receiving the graphics data therefrom to perform the video processing specified in the texture and video request on the graphics data.

A graphics processing unit (GPU) is provided. An exemplary embodiment of the GPU comprises a vertex shader receiving image data for coordination transformation and lighting; a setup engine assembling the image data received from the vertex shader into triangles; a primitive engine converting the assembled triangles into pixel data; a pixel shader performing a rendering process on the pixel data received from the primitive engine, including generating a texture and video request with respect to each pixel data set to fetch texture data therefor and for video processing required therefor; a texture engine receiving the texture and video request from the pixel shader, providing the texture data to the pixel shader in accordance with the texture and video request and applying the video processing specified in the texture and video request on the pixel data for output to the pixel shader; and a writeback engine writing back a final pixel value for each pixel data received from the pixel shader.

A graphics processing unit (GPU) is provided. An exemplary embodiment of the video processing method comprises receiving a texture and video request for a pixel, including location information of texture data for the pixel in a texture map stored in a memory unit and information of video functions required for the pixel; computing memory addresses of the texture data in the memory unit and graphics data required for the pixel when performing the video functions specified in the texture and video request in the memory unit; retrieving a copy of the graphics data and the texture data from the memory unit with the memory addresses; and performing the video functions on the graphics data.

### BRIEF DESCRIPTION OF DRAWINGS

The invention can be more fully understood by reading the subsequent detailed description and examples with references made to the accompanying drawings, wherein:

FIG. 1 is a block diagram of a conventional graphics processing unit (GPU).

FIG. 2 a block diagram of a GPU according to an embodiment of the invention.

FIG. 3 is a block diagram of the pixel shader and texture engine in FIG. 2 according to an embodiment of the invention.

FIG. 4 shows a detailed structure of the video process unit according to an embodiment of the invention.

FIG. 5 is a flowchart showing a video processing method in a texture engine according to an embodiment of the invention.

### DETAILED DESCRIPTION OF INVENTION

The following description comprises the best-contemplated mode of carrying out the invention. This description is made for the purpose of illustrating the general principles of the invention and should not be taken in a limiting sense. The scope of the invention is best determined by reference to the appended claims.

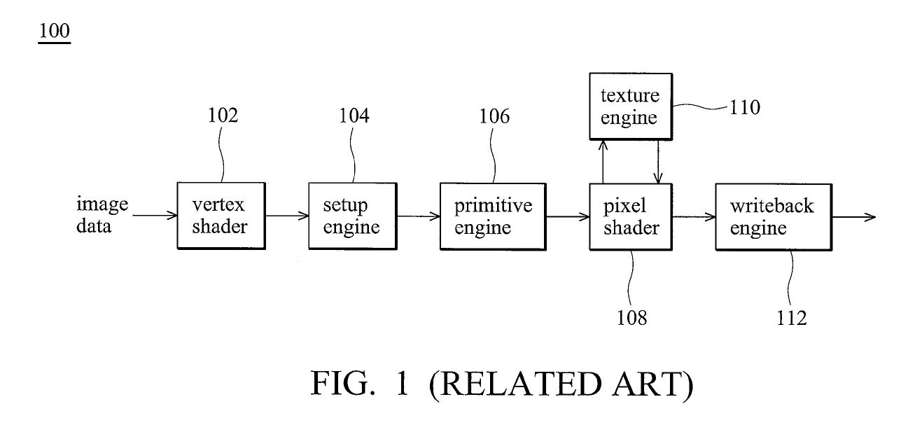

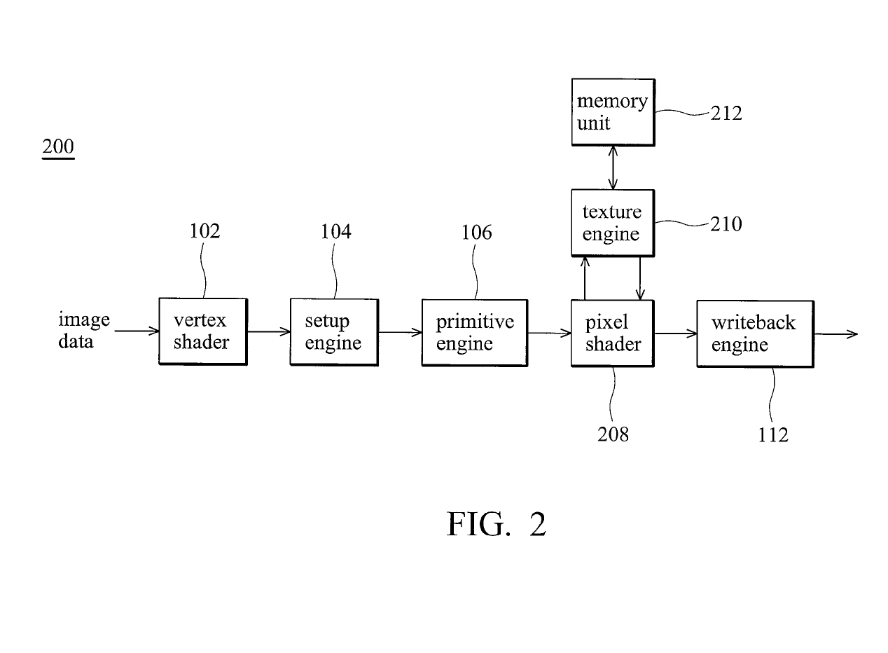

FIG. 2 shows a GPU 200 according to an embodiment of the invention. The GPU 200 is similar to the GPU 100 in FIG. 1 except for a pixel shader 208, a texture engine 210, and a memory unit 212. FIG. 2 uses the same reference numerals on elements shown as FIG. 1 which perform the same functions, and thus are not described in further detail. In addition to perform rendering process as conventional pixel shader, the pixel shader 208 dispatches a texture and video request with respect to each pixel data set to the texture engine 210 to fetch texture data therefor and allow the texture engine 210 to apply video processing on the pixel data according to the texture and video request. The texture engine 210 determines and provides the texture data to the pixel shader 208 in accordance with the received texture and video request, performs the video processing specified in the texture and video request on the pixel data, and outputs to the pixel shader 208. The memory unit 212, a local memory in a graphics card or a system memory in an integrated graphic chip, stores a plurality of texture maps and graphics data accessed by the texture engine 210.

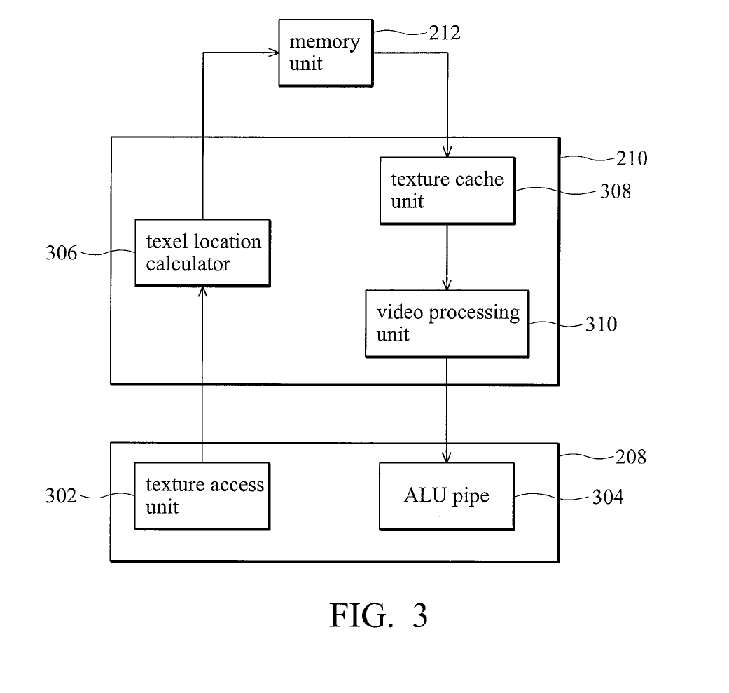

FIG. 3 shows detailed structures of the pixel shader 208 and the texture engine 210 in FIG. 2 according to an embodiment of the invention. The pixel shader 208 comprises a texture access unit 302 and an arithmetic logic unit (ALU) pipe 304. The texture access unit 302 generates the texture and video request with respect to each pixel data set to the texture engine 210, wherein the texture and video request includes location information of the texture data required for the pixel data in a texture map stored in the memory unit 212 and information of the video processing required for the pixel data. The texture engine 210 comprises a texel location calculator 306, a texture cache unit 308 and a video processing unit 310. Receiving the texture and video request from the texture access unit 302 of the pixel shader 208, the texel location calculator 306 determines the texture data required for the pixel data and computes the memory address of the texture data in a texture map stored in the memory unit 212 in accordance with the information contained in the texture and video request.

Moreover, according to the texture and video request, the texel location calculator 306 also computes the memory addresses of graphics data in the memory unit 212. The texture cache unit 308 retrieves a copy of graphics data and texture data from the memory unit 212 with the memory addresses computed by the texel location calculator 306. The video processing unit 310, coupled to the texture cache unit 308, receives the graphics data therefrom and performs the video processing function required for the pixel data and specified in the texture and video request on the graphics data. The video processing unit 310 then outputs the texture data required in the texture and video request and graphics data after the video processing specified in the texture and video request to the ALU pipe 304 which then performs three-dimensional (3D) graphics computations thereon.

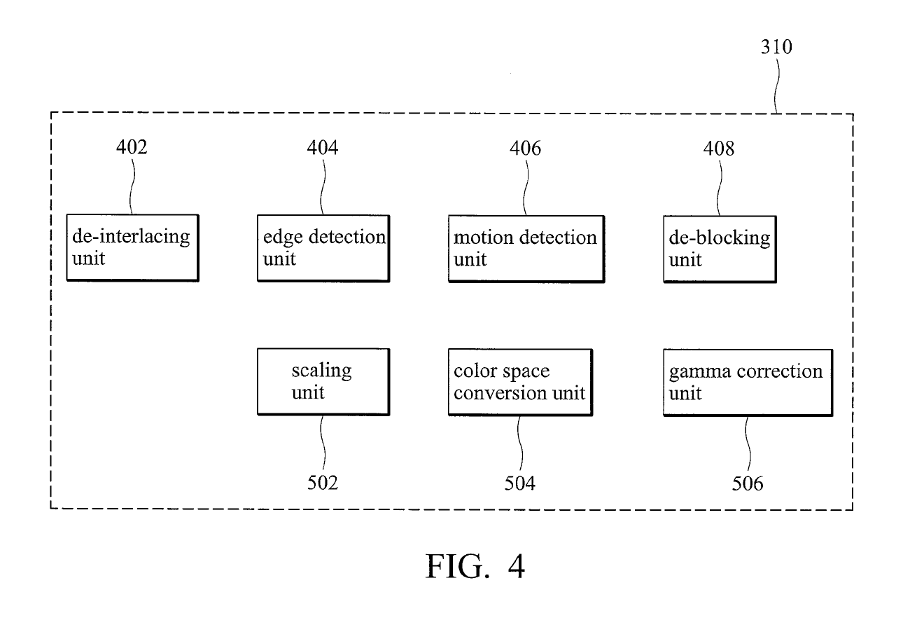

FIG. 4 shows a detailed structure of the video process unit 310 according to an embodiment of the invention. The video process unit 310 may comprise a de-interlacing unit 402, an edge detection unit 404, a motion detection unit 406, a de-blocking unit 408, a scaling unit 502, a color space conversion unit 504, and a gamma correction unit 506. The de-interlacing unit 402 is required when the input graphics data is in field format for conversion to frame mode. Various algorithms such as statistics-based or real-time estimation-based algorithms can be utilized in the edge detection unit 404 and motion detection unit 406. The de-block unit 408 eliminates rings appearing in the boundary of an image block. To perform de-block operations, the texture cache unit 308 retrieves these boundary pixels in the image block and the de-block unit 408 may simply apply filtering thereon. The scaling unit 502 may apply up-sampling or down sampling algorithms. For both algorithms, new rows or columns are obtained from the weighted sum of the neighboring rows or columns. Thus, the texture cache unit 308 may store these pixels of the neighboring rows and columns for scaling operations The-color space conversion unit 504 is required for graphics data input with different color formats while in the GPU, the color format of the pixel data is uniform. Further, to adjust non-linear display devices, the gamma correction unit 506 may be applied to perform gamma correction on the pixel data before displaying. Those skilled in the art may include other video processing units in accordance with design necessities.

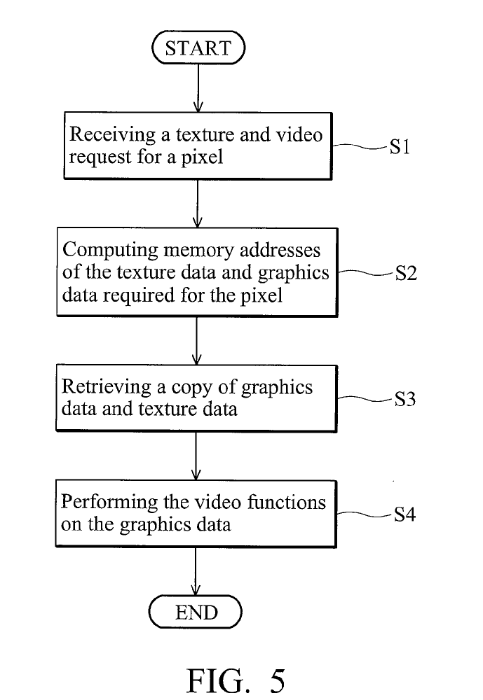

FIG. 5 is a flowchart showing a video processing method in a texture engine according to an embodiment of the invention. First, a texture and video request for a pixel is received (S1). Here, the texture and video request may comprise location information of texture data for the pixel in a texture map stored in a memory unit 212 shown in FIG. 2 and information of video functions required for the pixel. Next, memory addresses of the texture data in the memory unit and graphics data required for the pixel is computed when performing the video functions specified in the texture and video request in the memory unit (S2). Next, a copy of graphics data and texture data is retrieved from the memory unit with the memory addresses (S3). Finally, the video functions specified in the texture and video request are performed on the graphics data (S4). The video functions may comprise such as, for example, performing de-interlacing operations, edge detection, motion detection, de-block operations, scaling processing, color space conversion, or gamma correction on the graphics data.

In the invention, the texture engine 210 not only provides texture data for the pixel data to the pixel shader 208 as conventional texture engines but also performs video operations on pixel data. Thus, the corresponding execution time required for the video operations on the pixel data is reduced, improving the execution efficiency of the pixel shader. For example, to apply 4×4 filter and color space conversion operation with the texture engine of the invention, the PS code therefor is as follows.
texld r0, t0, s0//define s0 with 4×4 filter and color space conversion Mov oC0.rgba r0.rgba

### Obviously, the execution time of the pixel shader is reduced compared to the PS code listed in the Table 1.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A texture engine capable of performing video processing in a graphics processing unit (GPU), comprising:
a texel location calculator configured to compute memory addresses of the texture and the graphics data of a pixel in a memory unit, wherein the pixel being indicated in a received texture and video request including location information of texture data in a texture map stored in the memory unit;
a texture cache unit retrieving a copy of the graphics data and the texture data from the memory unit with the memory addresses computed by the texel location calculator; and
a video processing unit, coupled to the texture cache unit, receiving the graphics data therefrom to perform the video processing specified in the texture and video request on the copy of the graphics and the texture data.

2. The texture engine as claimed in claim 1, wherein the video processing unit further comprises a combination being selected from a group of:
a de-interlacing unit performing de-interlacing operations on the graphics data;
an edge detection unit performing edge detection on the copy of the graphics and the texture data;
a motion detection unit performing motion detection on the copy of the graphics and the texture data;
a de-blocking unit performing de-block operations on the copy of the graphics and the texture data;
a scaling unit performing scaling processing on the copy of the graphics and the texture data;
a color space conversion unit performing color space conversion on the copy of the graphics and the texture data; and
a gamma correction unit performing gamma correction on the copy of the graphics and the texture data.

3. A graphics processing unit (GPU) comprising:
a vertex shader receiving image data for coordination transformation and lighting;
a setup engine assembling the image data received from the vertex shader into triangles;
a primitive engine converting the assembled triangles into pixel data;
a pixel shader performing a rendering process on the pixel data received from the primitive engine, including generating a texture and video request with respect to each pixel data set to fetch texture data therefor and for video processing required therefor;
a texture engine receiving the texture and video request from the pixel shader, providing the texture data to the pixel shader in accordance with the texture and video request and applying the video processing specified in the texture and video request on the pixel data for output to the pixel shader; and
a writeback engine writing back a final pixel value for each pixel data received from the pixel shader.

4. The graphics processing unit (GPU) as claimed in claim 3, wherein the pixel shader comprises:
a texture access unit generating the texture and video request with respect to each pixel data set to the texture engine; and
an arithmetic logic unit (ALU) pipe receiving the texture data and pixel data after the video processing from the texture engine to perform three-dimensional (3D) graphics computations thereon.

5. The graphics processing unit as claimed in claim 3, wherein the texture engine comprises:
a texel location calculator is configured to compute memory addresses of the texture and the graphics data of a pixel in a memory unit, wherein the pixel being indicated in a received texture and video request, from the pixel shader, including location information of texture data in a texture map stored in the memory unit;
a texture cache unit retrieving a copy of graphics data and texture data from the memory unit with the memory addresses computed by the texel location calculator; and
a video processing unit, coupled to the texture cache unit, receiving the graphics data therefrom to perform the video processing specified in the texture and video request on the copy of the graphics and the texture data.

6. The graphics processing unit as claimed in claim 5, wherein the video processing unit further comprises a combination being selected from a group of:
a de-interlacing unit performing de-interlacing operations on the graphics data;
an edge detection unit performing edge detection on the copy of the graphics and the texture data;
a motion detection unit performing motion detection on the copy of the graphics and the texture data;
a de-blocking unit performing de-block operations on the copy of the graphics and the texture data;
a scaling unit performing scaling processing on the copy of the graphics and the texture data;
a color space conversion unit performing color space conversion on the copy of the graphics and the texture data; and
a gamma correction unit performing gamma correction on the copy of the graphics and the texture data.

7. A video processing method, comprising:
receiving a texture and video request for a pixel, including location information of texture data for the pixel in a texture map stored in a memory unit and information of video functions required for the pixel;
computing memory addresses of the texture data in the memory unit and graphics data required for the pixel;
retrieving a copy of the graphics data and the texture data from the memory unit with the memory addresses; and
performing the video processing on the copy of the graphics and the texture data according to the texture and video request.

8. The video processing method as claimed in claim 7, wherein the video processing further comprises a combination being selected from a group of:
performing de-interlacing operations on the copy of the graphics and the texture data;
performing edge detection on the copy of the graphics and the texture data;
performing motion detection on the copy of the graphics and the texture data;
performing de-block operations on the copy of the graphics and the texture data;
performing scaling processing on the copy of the graphics and the texture data;
performing color space conversion on the copy of the graphics and the texture data; and
performing gamma correction on the copy of the graphics and the texture data.
